(19) United States
(12) Patent Application Publication
(10) Pub. No.: US 2014/0212079 A1
(43) Pub. Date: Jul. 31, 2014

(54) DISK DRIVE UNIT

(71) Applicant: Samsung Electro-Mechanics Japan Advanced Technology Co., Ltd., Shizuoka (JP)

(72) Inventors: Mitsuo KODAMA, Shizuoka (JP); Ryusuke Sugiki, Shizuoka (JP)

(73) Assignee: Samsung Electro-Mechanics Japan Advanced technology Co., Ltd., Shizuoka (JP)

(21) Appl. No.: 14/151,906

(22) Filed: Jan. 10, 2014

(30) Foreign Application Priority Data
Jan. 29, 2013 (JP) 2013-014621

(51) Int. Cl. G11B 33/14

(52) U.S. Cl. CPC G11B 33/1473
USPC 384/100

(57) ABSTRACT

A disk drive unit includes a rotor including a disk setting part on which a disk is set, a bearing unit configured to rotatably support the rotor, wherein the bearing unit includes a shaft member and a bearing member surrounding the shaft member, and a lubricant provided in a gap between the shaft member and the bearing member, a fixed body configured to support the bearing unit, and a capturing body, provided in a space communicating from a gas-liquid interface of the lubricant to a disk accommodating space in which the disk is accommodated, configured to capture the lubricant vaporizing from the gas-liquid interface.

### CROSS-REFERENCE TO RELATED APPLICATIONS

This application is based upon and claims the benefit of priority of Japanese Patent Application No. 2013-014621 filed on Jan. 29, 2013, the entire contents of which are incorporated herein by reference.

### BACKGROUND OF THE INVENTION

1. Field of the Invention

The present invention relates to a disk drive unit.

2. Description of the Related Art

A disk drive unit, such as a HDD (Hard Disk Drive), for example, is one type of a rotating device. The disk drive unit may use a fluid dynamic bearing that rotatably supports a disk by providing a lubricant between a shaft member and a bearing member. In the disk drive unit mounted with the fluid dynamic bearing, it may be important, from the point of view of enabling the use of the disk drive unit for a long time without an operation error, to manage an existing state of the lubricant, such as the amount of lubricant and an interface position of the lubricant, and to prevent leaking of the lubricant.

In order to accurately and easily confirm the interface position of the lubricant, a fluid dynamic bearing mechanism having a seal member formed by a translucent material has been proposed in Japanese Laid-Open Patent Publication No. 2010-127448, for example. Further, in order to prevent leaking of the lubricant, a fluid dynamic bearing unit having a bearing member formed with a ring-shaped groove to hold the lubricant that is provided to a predetermined lubricant level has been proposed in Japanese Laid-Open Patent Publication No. 2009-162246, for example.

However, in the disk drive unit having the fluid dynamic bearing, the lubricant may vaporize from a gas-liquid interface and adhere on the disk surface through a gap or the like. In such a case, an operation error may occur during a read or a write with respect to the disk. Disk contamination caused by the vaporized lubricant adhering onto the disk surface may also occur in the configurations proposed in the Japanese Laid-Open Patent Publications No. 2010-127448 and No. 2009-162246 described above, and cause the operation error of the disk drive unit.

### SUMMARY OF THE INVENTION

Embodiments of the present invention may provide a disk drive unit that may prevent adhesion of the lubricant onto the disk surface, and reduce generation of the operation error.

According to one aspect of the present invention, a disk drive unit may include a rotor including a disk setting part on which a disk is set; a bearing unit configured to rotatably support the rotor, wherein the bearing unit includes a shaft member and a bearing member surrounding the shaft member, and a lubricant provided in a gap between the shaft member and the bearing member; a fixed body configured to support the bearing unit; and a capturing body, provided in a space communicating from a gas-liquid interface of the lubricant to a disk accommodating space in which the disk is accommodated, configured to capture the lubricant vaporizing from the gas-liquid interface.

According to another aspect of the present invention, a disk drive unit may include a rotor including a disk setting part on which a disk is set; a bearing unit configured to rotatably support the rotor, wherein the bearing unit includes a shaft member and a bearing member surrounding the shaft member, and a lubricant provided in a gap between the shaft member and the bearing member; a fixed body configured to support the bearing unit; and a porous element, having at least a part thereof formed by a porous material, provided in a space communicating from a gas-liquid interface of the lubricant to a disk accommodating space in which the disk is accommodated.

Other objects and further features of the present invention may be apparent from the following detailed description when read in conjunction with the accompanying drawings.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIGS. 1A, 1B, and 1C are diagrams for explaining an example of a configuration of a disk drive unit in a first embodiment;

FIG. 2 is a cross sectional view illustrating the configuration of one part of the disk drive unit in the first embodiment; and

FIG. 3 is a cross sectional view illustrating the configuration of one part of the disk drive unit in a second embodiment.

### DESCRIPTION OF THE PREFERRED EMBODIMENTS

In each of the figures described hereunder, those elements and parts that are the same or substantially the same are designated by the same reference numerals, and a description thereof will not be repeated where appropriate. In addition, dimensions of the parts in each of the figures are enlarged or reduced, where appropriate, in order to facilitate understanding of the parts. Further, in each of the figures, illustration of some of the parts that may be considered unimportant in describing embodiments is omitted for the sake of convenience.

### First Embodiment

A description will be given of the disk drive unit, which is one type of a rotating device, in a first embodiment of the present invention.

The disk drive unit in the first embodiment may include a fixed-shaft type fluid dynamic bearing in which a lubricant exists between a shaft member and a bearing member, and a capturing body that captures the lubricant vaporizing from a gas-liquid interface. The gas-liquid interface may include an air-liquid interface or a vapor-liquid interface, and the lubricant vaporizing from the gas-liquid interface may include the lubricant evaporating from the gas-liquid interface.

<Configuration of Disk Drive Unit>

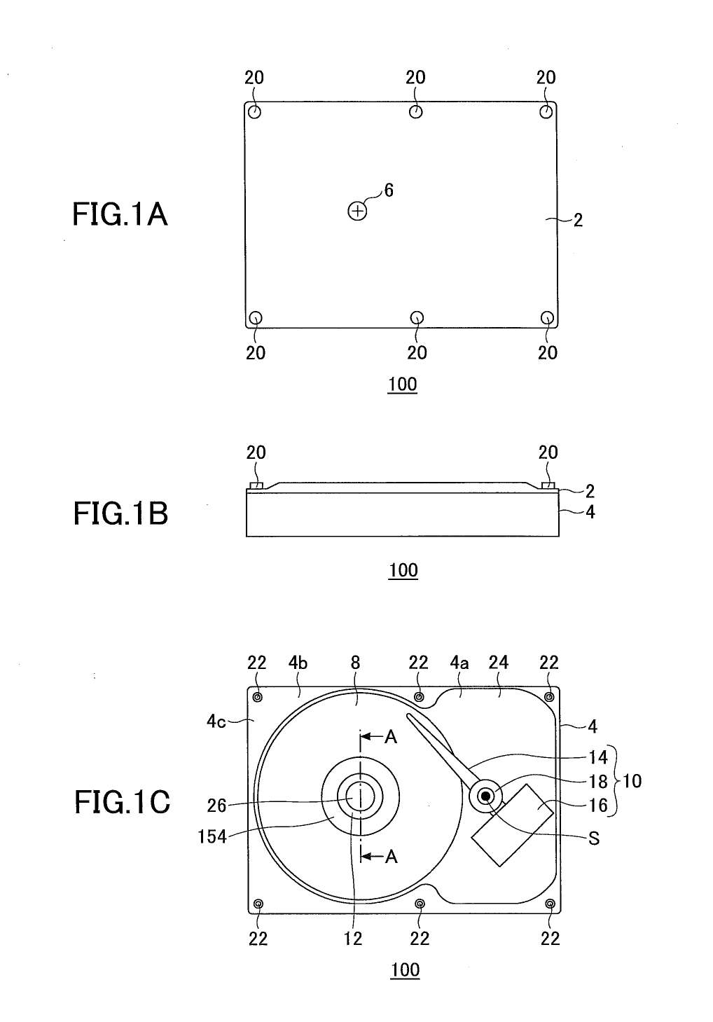

A description will be given of a configuration of a disk drive unit 100, by referring to FIGS. 1A, 1B, and 1C. FIGS. 1A, 1B, and 1C illustrate the disk drive unit 100 in the first embodiment. FIG. 1A illustrates a top view (or plan view) of the disk drive unit 100, FIG. 1B illustrates a side view of the disk drive unit 100, and FIG. 1C illustrates a top view of the disk drive unit 100 in a state in which a top cover 2 is removed.

The disk drive unit 100 may include the top cover 2 and a base 4. A magnetic recording disk 8 and a data read and write part 10 may be provided in a space between the top cover 2 and the base 4.

In the following description, an end (or side) of the top cover 2 may also be referred to as an upper end (or upper side), and an end (or side) of the base 4 may also be referred to as a lower end (or lower side) of the disk drive unit 100.

(Base)

As illustrated in FIG. 1C, the base 4 may include a bottom plate part 4a that forms a bottom part of the disk drive unit 100, and an outer peripheral wall part 4b that is formed along an outer periphery of the bottom plate part 4a so as to surround a mounting region in which a magnetic recording disk 8 is to be mounted. An upper surface 4c of the outer peripheral wall part 4b includes six (6) screw holes 22 that are used to mount the top cover 2.

The base 4 in the first embodiment may be formed by die casting an aluminum alloy. For example, the base 4 may be formed by pressing a metal plate, such as an aluminum plate, a steel plate, and the like. In this latter case, an embossing may be performed in order to form projections on the upper side of the base 4. By performing the embossing at predetermined parts of the base 4, deformation of the base 4 may be suppressed. In addition, when forming the base 4 by the pressing, a surface treatment, such as plating, resin coating, and the like may be performed on the base 4. For example, after forming the base 4 by pressing the metal plate, a nickel plated layer and an epoxy resin surface layer may be provided on the base 4.

In addition, the base 4 may be formed by a combination of a metal plate part that is formed by pressing the metal plate, such as the aluminum plate, the steel plate, and the like, and a die cast part that is formed by aluminum die casting. For example, the bottom plate part 4a may be formed to include the metal plate part, and the outer peripheral wall part 4b may be formed to include the die cast part. By employing this combination configuration, rigidity deterioration of the screw holes 22 may be suppressed. In this case, the die cast part may be formed by the aluminum die casting in a state in which the preformed metal plate part is set in a die that is used for the aluminum die casting. According to this method of fabricating the base 4, a process to connect the metal plate part and the die cast part may be omitted, and a dimension accuracy of the metal plate part and the die cast part may be improved. Further, a separate part or member used to connect the metal plate member and the die cast part may be reduced or eliminated, and as a result, the base 4 may be made thin.

(Top Cover)

As illustrated in FIGS. 1A and 1B, the top cover 2 may be fixed to the upper surface 4c of the outer peripheral wall part 4b of the base 4, by screwing six (6) screws into the screw holes 22 that are provided in the upper surface 4c of the base 4. In addition, a shaft 26 may be fixed to a lower surface of the base 4 by a shaft securing screw 6.

(Disk Accommodating Space)

A disk accommodating space 24 may be formed between the top cover 2 and the base 4. The disk accommodating space 24 may accommodate the magnetic recording disk 8. The disk accommodating space 24 may be filled with clean air removed of dust, in order to prevent contaminating particles from adhering onto the surface of the magnetic recording disk 8 and to improve the reliability of the operation of the disk drive unit 100. Accordingly, the top cover 2 and the base 4 are provided to seal the disk accommodating space 24 so that the dust does not enter the disk accommodating space 24 from the atmosphere.

(Magnetic Recording Disk)

The magnetic recording disk 8 may be set on a hub (not illustrated) that surrounds the shaft 26, and rotate together with the hub. For example, the magnetic recording disk 8 may be formed by a 2.5-inch type magnetic recording disk made of glass and having a diameter of 65 mm, a thickness of 0.65 mm, and a center hole with a diameter of 20 mm. In this example, three (3) magnetic recording disks 8 may be accommodated within the disk drive unit 100.

The magnetic recording disk 8 may be pushed by a clamper 154 against the hub together with a spacer (not illustrated), and fixed to the hub. Hence, the magnetic recording disk 8 may rotated together with the hub about the shaft 26 as its center of rotation. A cap 12 may suppress the lubricant that is provided between the shaft 26 and a sleeve (not illustrated) that surrounds the shaft 26 from scattering into the disk accommodating space 24.

(Data Read and Write Part)

The data read and write part 10 may include a recording and reproducing head (not illustrated), a swing arm 14, a voice coil motor 16, and a pivot assembly 18, as illustrated in FIG. 1C.

The recording and reproducing head may be mounted on a tip end of the swing arm 14, and record (or write) data to the magnetic recording disk 8 and reproduce (or read) data from the magnetic recording disk 8.

The pivot assembly 18 pivotally supports the swing arm 14 with respect to the base 4 about a head rotational axis S as its center of pivoting.

The voice coil motor 16 swings the swing arm 14 about the head rotational axis S as its center of swing, and moves the recording and reproducing head to a desired position on an upper surface of the magnetic recording disk 8. The voice coil motor 16 and the pivot assembly 18 may be formed using a known technique to control the head position.

<Configuration of Bearing Mechanism>

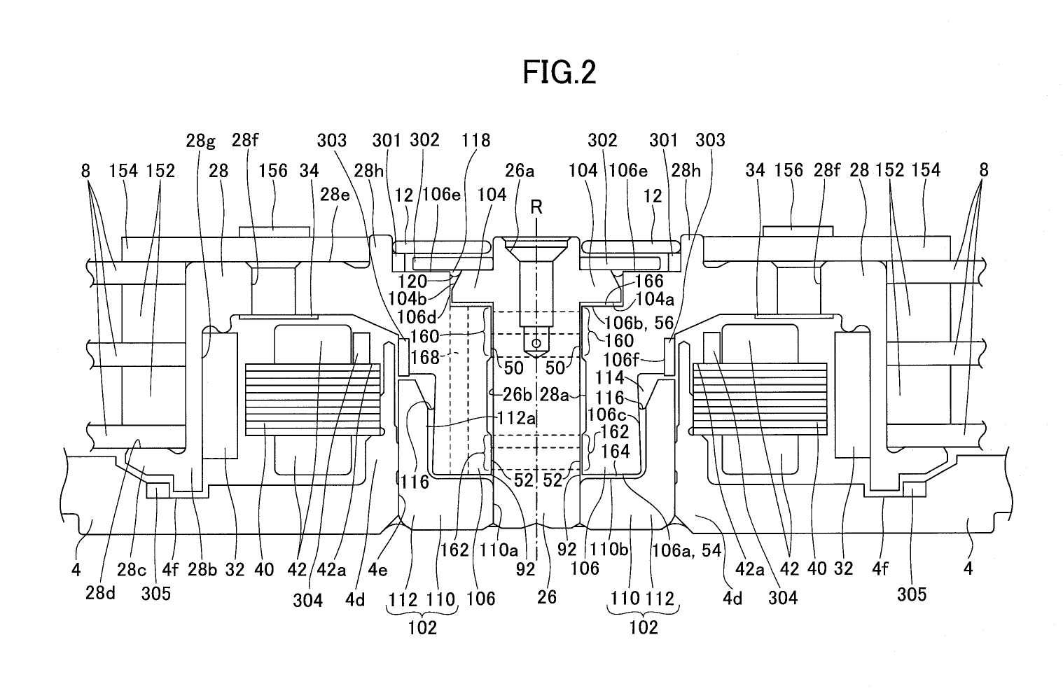

A description will be given of a bearing mechanism of the disk drive unit 100, by referring to FIG. 2. FIG. 2 illustrates a cross sectional view of the disk drive unit 100 along a line A-A in FIG. 1C. In the following description, a direction perpendicular to a rotational axis R may also be referred to as a radial direction, an end (or side) further away from the rotational axis R along a radial direction of the magnetic recording disk 8 may also be referred to as an outer peripheral side, and an end (or side) closer to the rotational axis R along the radial direction may also be referred to as an inner peripheral side.

The disk drive unit 100 may include a rotor that is set with the magnetic recording disk 8 and rotates, a bearing unit that rotatably supports the rotor, and a fixed body that supports the bearing unit.

The rotor may include a hub 28, a cylindrical magnet 32, the cap 12, and the clamper 154. The bearing unit may include the shaft 26, a housing 102, and a sleeve 106. The shaft 26 may be an example of the shaft member, and the housing 102 and the sleeve 106 may be an example of the bearing member. The fixed body may include the base 4, a laminated (or stacked) core 40, and a coil 42. The laminated core 40 may be an example of a stator core.

In the disk drive unit 100 of the first embodiment, the hub 28 and the sleeve 106 may be formed integrally, and the sleeve 106 may be formed as a part of the hub 28. The hub 28 may surround the shaft 26 by the sleeve 106, and rotate by being supported by the shaft 26 and the housing 102. A lubricant 92 may be provided in a gap between the sleeve 106 and the shaft 26.

(Hub)

The hub 28 may include a center hole 28a that is formed along the rotational axis R, and the sleeve 106 that surrounds the shaft 26 inserted into the center hole 28a. The hub 28 and the sleeve 106 may be formed as separate parts. By forming the hub 28 and the sleeve 106 as separate parts, each of the hub 28 and the sleeve 106 may be formed with ease. On the other hand, when the hub 28 and the sleeve 106 are formed integrally as in the first embodiment, the dimension accuracy of the center hole 28a and the like may be improved.

In addition, the hub 28 may include a hub projecting part 28b that fits into the center hole of the magnetic recording disk 8, a disk setting part 28c that is provided on the outer peripheral side of the hub projecting part 28b, and a disk setting surface 28d on which the magnetic recording disk 8 may be set.

Three (3) stacked magnetic recording disks 8 having a ring-shaped spacer 152 interposed between each of two (2) mutually adjacent magnetic recording disks 8 are set on the disk setting surface 28d of the disk setting part 28c. The magnetic recording disks 8 are fixed to the hub projecting part 28b together with the spacers 152, by being sandwiched between the clamper 154 and the disk setting part 28c.

The hub 28 may be formed from a soft magnetic steel material such as SUS430F or aluminum, for example. The hub 28 may be formed by pressing or cutting the steel or aluminum material, and may be formed to an approximate cup shape having the center hole 28a.

The steel material preferably used for the hub 28 may be stainless steel DHS1 supplied by Daido Steel Co., Ltd., for example, which is low in outgas and easy to press and cut. In addition, the steel material used for the hub 28 may be stainless steel DHS2 supplied by Daido Steel Co., Ltd., for example, which may further be preferable due to its anti-corrosion characteristic. A surface treatment, such as plating, resin coating, and the like may be performed on the hub 28. The hub 28 in the first embodiment may include a surface layer formed by electroless nickel plating, in order to suppress peeling of micro residue adhered on the processed surface.

(Clamper)

The clamper 154 may be fixed to an upper surface 28e of the hub 28 by a plurality of clamps screws 156. The clamp screws 156 are screwed into clamp screw holes 28f provided in the hub 28, in order to fix the clamper 154 to the hub 28. The clamp screw holes 28f penetrate the hub 28, and a lower end of the clamp screw holes 28f may be closed by a closing means 34 such as a tape, for example. Because the clamp screw holes 28f have a shape penetrating the hub 28, the clamp screw holes 28f may be formed with ease. In addition, because the closing means 34 may close the clamp screw holes 28f, upward scattering of the lubricant 92 through the clamp screw holes 28f may be prevented.

(Cylindrical Magnet)

The cylindrical magnet 32 may be bonded and fixed to a cylindrical inner peripheral surface 28g on the inner peripheral side of the projecting part 28b of the hub 28. The cylindrical magnet 32 may be formed from a rare earth magnetic material, a ferrite magnetic material, or the like, for example. The cylindrical magnet 32 in the first embodiment may be formed from a neodymium rare earth magnetic material.

The cylindrical magnet 32 may be magnetized to have sixteen (16) poles, for example, along a circumferential direction of a circle about the rotational axis R as its center in a cross section perpendicular to the rotational axis R. A surface layer may be formed on the surface of the cylindrical magnet 32 by electro-coating, spray coating, or the like, for example, in order to suppress corrosion. The cylindrical magnet 32 may oppose twelve (12) salient poles of the laminated core 40 in a radial direction.

(Laminated Core)

The laminated core 40 may include a cylindrical part and the twelve (12) salient poles extending from the cylindrical part towards the outer peripheral side. The laminated core 40 may be formed by laminating ten (10) thin magnetic steel plates, and crimping or caulking the thin magnetic steel plates in order to integrally form the laminated core 40. An insulator coating may be formed on the surface of the laminated core 40 by electro-coating, powder coating, or the like, for example. The coil 42 may be wound on each salient pole of the laminated core 40. A driving magnetic flux is generated along the salient poles when a 3-phase driving current having an approximately sinusoidal waveform flows to the coil 42.

A cylindrical base projecting part 4d having the rotational axis R as its center may be provided on the base 4. The base projecting part 4d may surround the housing 102 and project upwards from the lower surface of the base 4. The laminated core 40 may be fitted to the outer peripheral surface of the base projecting part 4d, so that the outer peripheral surface of the base projecting part 4d fits into a center hole in the cylindrical part of the laminated core 40. The cylindrical part of the laminated core 40 may be press fit, or bonded, or press fit and bonded to the base projecting part 4d.

The core is not limited to the laminated core 40, and for example, a solid core may be used in place of the laminated core 40. In addition, although the disk drive unit 100 in the first embodiment is the so-called outer rotor type in which the cylindrical magnet 32 is located on the outer side of the laminated core 40, the disk drive unit 100 may be the so-called inner rotor type in which the cylindrical magnet 32 is located on the inner side of the laminated core 40.

(Housing)

The housing 102 may include a flat ring-shaped shaft holding part 110, and a ring-shaped sleeve surrounding part 112 that is fixed on the outer peripheral side of the shaft holding part 110. The sleeve surrounding part 112 may surround the side end part of the base 4.

The housing 102 may be formed by connecting the shaft holding part 110 and the sleeve surrounding part 112 that are formed as separate parts. By forming the housing 102 as separate parts, each of the shaft holding part 110 and the sleeve surrounding part 112 may be formed with ease. On the other hand, when the shaft holding part 110 and the sleeve surrounding part 112 are formed integrally as in the first embodiment, fabrication error may be reduced and a bonding process may be simplified.

The housing 102 may be fixed to the base 40 by press fitting, or bonding, or press fitting and bonding the sleeve surrounding part 112 into a center hole 4e that is provided on the inner peripheral side of the base projecting part 4d and has the rotational axis R as its center. The shaft holding part 110 of the housing 102 may include a shaft hole 110a having the rotational axis R as its center, and the shaft 26 may be press fit, or bonded, or press fit and bonded into the shaft hole 110a in order to fix and hold the shaft 26.

The housing 102 may be formed from a copper alloy, a sintered alloy made by powder metallurgy, stainless steel, plastic materials such as polyetherimide, polyimide, and polyamide, or the like, for example. In a case in which the plastic material is used for the housing 102, carbon fiber may be included in the plastic material to make the resistivity 10⁶ (Ω·m) or less, in order to secure an electrostatic eliminating function of the disk drive unit 100.

(Shaft)

The shaft 26 may include a securing screw hole 26a at an upper surface thereof. An upper end of the shaft 26 may be fixed to the cover 2 by screwing the shaft securing screw 6 into the securing screw hole 26a by penetrating the top cover 2. In addition, a lower end of the shaft 26 may be press fit, or bonded, or press fit and bonded into the shaft hole 110a of the housing 102 and fixed to the housing 102. The disk drive unit 100 may have a superior shock resistance and vibration resistance due to the structure in which both ends of the shaft 26 are fixed to and supported by the base 4 via the top cover 2 and the housing 102, respectively.

A flange surrounding part 104 may be provided at the upper end side of the shaft 26. The flange surrounding part 104 may be formed as a separate part from the shaft 26. The flange surrounding part 104 and the shaft 26 may be formed with ease by forming the flange surrounding part 104 and the shaft 26 as separate parts. In the first embodiment, the shaft 26 and the flange surrounding part 104 may be formed integrally. When the shaft 26 and the flange surrounding part 104 are formed integrally as in the first embodiment, the strength and the dimension accuracy of the flange surrounding part 104 may be improved.

The shaft 26 may be formed by cutting stainless steel such as SUS420J2 or the like, for example.

(Sleeve)

The sleeve 106 of the hub 28 may surround the shaft 26, and the hub 28 and the sleeve 106 may be formed integrally. Although the hub 28 and the sleeve 106 are formed integrally in the first embodiment, the hub 28 and the sleeve 106 may be formed as separate parts.

When forming the hub 28 and the sleeve 106 as separate parts, the sleeve 106 may be formed by cutting a base material made of brass, aluminum, stainless steel DHS1, or the like, for example, into a desired shape, and subjecting the desired shape to a nickel plating, for example.

The sleeve 106 may surround a part from an upper portion of the part of the shaft 26 held by the shaft holding part 110 of the housing 102 up to the flange surrounding part 104. The lubricant 92 may be provided in the gap between the sleeve 106 and the shaft 26 and a gap between the sleeve 106 and the housing 102.

(Dynamic Pressure Generator)

A first gap may be formed between an outer peripheral surface 26b of the shaft 26 and the inner peripheral surface of the sleeve 106. The lubricant 92 may be provided in this first gap.

In the first gap, a first radial dynamic pressure generator 160 may be formed at a lower portion of the flange surrounding part 104 of the shaft 26, and a second radial dynamic pressure generator 162 may be formed at an upper portion of the shaft holding part 110 of the housing 102. The first radial dynamic pressure generator 160 and the second radial dynamic pressure generator 162 may be formed at positions separated along the direction of the rotational axis (or axial direction).

The sleeve 106 may include a first radial dynamic pressure generating groove 50 having a herringbone shape or a spiral shape, for example, at a portion opposing the first radial dynamic pressure generator 160. In addition, the sleeve 106 may include a second radial dynamic pressure generating groove 52 having a herringbone shape or the spiral shape, for example, at a portion opposing the second radial dynamic pressure generator 162.

One of or both the first radial dynamic pressure generating groove 50 and the second radial dynamic pressure generating groove 52 may be formed on the outer peripheral surface 26b of the shaft 26. The first radial dynamic pressure generating groove 50 and the second radial dynamic pressure generating groove 52 may be formed by rolling, cutting, electrolytic etching, and the like, for example.

A second gap may be formed between a lower surface 106a of the sleeve 106 and an upper surface 110b of the shaft holding part 110 of the housing 102. The lubricant 92 may be provided in this second gap, in a manner similar to the first gap.

In the second gap, a first thrust dynamic pressure generator 164, that generates a dynamic pressure in the lubricant 92 along the direction of the rotational axis, may be formed when the hub 28 including the sleeve 106 rotates. The sleeve 106 may include a first thrust dynamic pressure generating groove 54 having a herringbone shape or a spiral shape, for example, in a lower surface 106a opposing the first thrust dynamic pressure generator 164. The first thrust dynamic pressure generating groove 54 may be formed in the upper surface 110b of the shaft holding part 110, instead of being formed in the lower surface 106a of the sleeve 106.

A third gap may be formed between the upper surface 106b of the sleeve 106 and a lower surface 104a of the flange surrounding part 104 of the shaft 26. The lubricant 92 may be provided in this third gap, in a manner similar to the first and second gaps.

In the third gap, a second thrust dynamic pressure generator 166, that generates a dynamic pressure in the lubricant 92 along the direction of the rotational axis, may be formed when the hub 28 including the sleeve 106 rotates. The sleeve 106 may include a second thrust dynamic pressure generating groove 56 having a herringbone shape or a spiral shape, for example, in the upper surface 106b opposing the second thrust dynamic pressure generator 166. The second thrust dynamic pressure generating groove 56 may be formed in the lower surface 104a of the flange surrounding part 104, instead of being formed in the upper surface 106b of the sleeve 106.

When the hub 28 including the sleeve 106 rotates with respect to the shaft 26, the dynamic pressure may be generated in the lubricant 92 at each of the first radial dynamic pressure generator 160, the second radial dynamic pressure generator 162, the first thrust dynamic pressure generator 164, and the second thrust dynamic pressure generator 166. The sleeve 106 may be supported along the radial direction and the direction of the rotational axis by the dynamic pressure generated in the lubricant 92, in a non-contact state in which no contact is made with the shaft 26 and the housing 102.

(Gas-Liquid Interface)

A first gas-liquid interface 116 of the lubricant 92 may be formed between a lower external surface 106c of the sleeve 106 and an inner peripheral surface 112a of the sleeve surrounding part 112. A first tapered seal 114, that has an interval gradually spreading in an upward direction, may be formed between the lower outer peripheral surface 106c of the sleeve 106 and the inner peripheral surface 112a of the sleeve surrounding part 112.

In addition, a second gas-liquid interface 120 of the lubricant 92 may be formed between an outer peripheral surface 104b of the flange surrounding part 104 of the sleeve 106 and an inner peripheral surface 106d of the sleeve 106 opposing the flange surrounding part 104. A second tapered seal 118, that has an interval gradually spreading in the upward direction, may be formed between the outer peripheral surface 104b of the flange surrounding part 104 and the inner peripheral surface 106d of the sleeve 106.

(Bypass Communicating Hole)

The sleeve 106 may include a bypass communicating hole 168 that bypasses the first thrust dynamic pressure generator 164 and the second thrust dynamic pressure generator 166. The bypass communicating hole 168 may penetrate the sleeve 106 along the direction of the rotational axis.

In a case in which a diameter d1 of the bypass communicating hole 168 is small, the lubricant 92 may exhibit an unanticipated behavior, due to a sudden change in the pressure applied to the lubricant 92 such as when the disk drive unit 100 moves up and down, shock is applied to the disk drive unit 100, and the like. For this reason, the diameter d1 of the bypass communicating hole 168 may be set as large as possible, in order to improve the stability of behavior of the lubricant 92. On the other hand, when the diameter d1 of the bypass communicating hole 168 is large, a large amount of the lubricant 92 may need to be held, and the cost of the lubricant 92 may increase due to the increased amount of the lubricant 92 used.

In the first embodiment, the bypass communicating hole 168 may be formed so that a ratio d1/d2 of the diameter d1 of the bypass communicating hole 168 with respect to a diameter d2 of the center hole 28a provided in the hub 28 (or sleeve 106) becomes greater than 0.13. For example, in a case in which the diameter d2 of the center hole 28a is 2.5 mm, the diameter d1 of the bypass communicating hole 168 may be set in a range of 0.35 mm to 0.50 mm. By configuring the bypass communicating hole 168 to have such a diameter d1, a pressure difference amongst regions of the lubricant 92 may be reduced, to thereby stabilize the behavior of the lubricant 92 and to suppress the increased cost of the lubricant 92 within a practical range.

(Cap)

The cap 12 may be formed by a ring-shaped member that is fixed by being bonded to the sub 28 so as to cover the second tapered seal 118 and the flange surrounding part 104. For example, the cap 12 may be formed by a resin material or a metal material such as stainless steel, brass, and the like.

The cap 12 may form a capturing space to capture the lubricant 92 vaporizing from the second gas-liquid interface 120, in a space surrounded by the flange surrounding part 104 and an upper surface 106e of the sleeve 106 opposing the cap 12. At least a portion of the lubricant 92 vaporizing from the second gas-liquid interface 120 may scatter towards the outer peripheral side due to centrifugal force, and be captured by the capturing space. By the provision of the capturing space formed by the cap 12, the amount of the lubricant 92 vaporizing to the disk accommodating space 24 may be suppressed.

The narrower the gap formed between the cap 12 and the shaft 26 in the radial direction, the smaller the amount of the lubricant 92 scattering into the disk accommodating space 24, however, the higher the probability of the cap 12 making contact with the shaft 26. Accordingly, the gap between the cap 12 and the shaft 26 may preferably be set to a suitable size such that the amount of the lubricant 92 scattering to the outside is reduced and the cap 12 is prevented from making contact with the shaft 26.

Although the upper and lower surfaces of the cap 12 described above are flat, one of or both the upper and lower surfaces of the cap 12 may include a projection or a recess. For example, the projection or recess may be provided in a circumferential direction on the lower surface of the cap 12. By providing the projection or recess on the cap 12, the upper end and the lower end of the cap 12 may be identified with ease, and it is easy to detect an erroneous mounting state of the cap 12 such as an upside-down mounting of the cap 12.

(Capturing Body)

The disk drive unit 100 may include the capturing body to capture the lubricant 92 vaporizing from the first gas-liquid interface 116 or the second vapor-liquid interface 120. The capturing body may be provided in a space communicating from the first gas-liquid interface 116 or the second gas-liquid interface 120 to the disk accommodating space 24 in which the magnetic recording disk 8 is accommodated.

At least a part of the capturing body preferably includes a part that is formed by a porous material capable of capturing the vaporized lubricant 92 in pores thereof. For example, a sintered metal, activated carbon including activated charcoal, and the like may be used for the porous material.

The disk drive unit 110 in the first embodiment may include, as the capturing body, a first capturing member 301, a second capturing member 302, a third capturing member 303, a fourth capturing member 304, and a fifth capturing member 305.

The first capturing member 301 may be formed by a ring-shaped member surrounding an end part of the shaft 26 opposite to the base 4, and be provided between the cap 12 and the upper surface 106e of the sleeve 106. The first capturing member 301 may be press fit, or bonded, or press fit and bonded between the upper surface 106e of the sleeve 106 and an upper projecting part 28h of the hub 28.

The lubricant 92 vaporizing from the second gas-liquid interface 120 when the hub 29 rotates may scatter towards the outer peripheral side due to the centrifugal force, between the cap 12 and the upper surface 106e of the sleeve 106, and be captured by the first capturing member 301. In addition, because an outer peripheral surface of the first capturing member 301 makes contact with the upper projecting part 28h of the hub 28, the lubricant 92 captured during the rotation of the hub 28 will not scatter again towards the outer peripheral side due to the centrifugal force.

Accordingly, the first capturing member 301 captures the lubricant 92 vaporizing from the second gas-liquid interface 120, in order to prevent the lubricant 92 from scattering to the disk accommodating space 24.

The second capturing member 302 may be formed by a ring-shaped member surrounding the end part of the shaft 26 opposite to the base 4, and be provided on the upper surface of the flange surrounding part 104 of the shaft 26 to cover at least a portion of the second gas-liquid interface 120 of the lubricant 92. The second capturing member 302 may be press fit, or bonded, or press fit and bonded between the upper surface of the flange surrounding part 104 and the shaft 26.

The second capturing member 302 may be provided to cover the second gas-liquid interface 120, and capture the lubricant 92 vaporizing from the second gas-liquid interface 120, in order to prevent the lubricant 92 from scattering to the disk accommodating space 24.

In addition, an air flow generating groove having a herringbone shape or a spiral shape, for example, may be formed in the lower surface of the second capturing member 302 at a portion opposing the upper surface 106e of the sleeve 106. The air flow generating groove may generate an air flow between the second capturing member 302 and the upper surface 106e of the sleeve 106 when the hub 28 rotates, in order to more positively prevent the lubricant 92 vaporized from the second gas-liquid interface 120 from scattering to the disk accommodating space 24. The air flow generating groove may be provided in the upper surface 106e of the sleeve 106 instead of being provided in the second capturing member 302.

The third capturing member 303 may be formed by a ring-shaped member surrounding the sleeve 106, and be provided on an upper outer peripheral surface 106f of the sleeve 106. The third capturing member 303 may be press fit, or bonded, or press fit and bonded to the sleeve 106. The third capturing member 303 may be provided on the upper outer peripheral surface 106f of the sleeve 106 at an upper portion of the sleeve surrounding part 112 of the housing 102, and capture the lubricant 92 vaporizing from the first gas-liquid interface 116 between the sleeve 106 and the sleeve surrounding part 112.

At least a portion of an outer peripheral surface of the third capturing member 303 may be covered by the base projecting part 4d. The lubricant 92 captured by the third capturing member 303 may be prevented from scattering by the base projecting part 4d, even when the lubricant 92 escapes the third capturing member 303 due to the centrifugal force when the hub 28 rotates.

The third capturing member 303 may capture the lubricant 92 vaporizing from the first gas-liquid interface 116 and prevent the lubricant 92 from scattering to the disk accommodating space 24, by the above described configuration thereof.

The third capturing member 303 may be press fit, or bonded, or press fit and bonded to an inner peripheral surface of the base projecting part 4d, instead of being fixed to the sleeve 106.

The fourth capturing member 304 may be provided on an inner peripheral side of the coil 24, and fixed by being bonded to an inner peripheral side upper surface 42a of the laminated core 40.

The fourth capturing member 304 may capture the lubricant 92 vaporized from the first gas-liquid interface 116 and scattering between the sleeve 106 and the sleeve surrounding part 112 of the housing 102, and between the sleeve 106 and the base projecting part 4d, in order to prevent the lubricant 92 from scattering to the disk accommodating space 24.

The fifth capturing member 305 may be formed by a ring-shaped member, and be provided in a gap between the opposing hub 28 and base 4, in a region on the outer peripheral side along the radial direction than the upper outer peripheral surface 106f of the sleeve 106. More particularly, the fifth capturing member 305 may be press fit, or bonded, or press fit and bonded to a circumferential recess 4f of the base to which the hub projecting part 28b of the hub 28 fits.

The circumferential recess 4f of the base 4 may be formed so that at least a portion of the lower end of the hub projecting part 28b fits into the circumferential recess 4f. The circumferential recess 4f may have an approximately rectangular cross section, and have a shape larger than that of the hub projecting part 28b on the outer peripheral side.

The fifth capturing member 305 may be provided on the end part of the circumferential recess 4f on the outer peripheral side to oppose the disk setting part 28c, on the outer peripheral side from the sub projecting part 28b. The fifth capturing member 305 may capture the lubricant 92 scattering between the sleeve 106 and the sleeve surrounding part 112 of the housing, and between hub 28 and each of the coil 42 and the laminated core 40, in order to prevent the lubricant 92 from scattering to the disk accommodating space 24.

The capturing body may have a shape other than the approximately rectangular cross sectional shape of the first through fifth capturing members 301 through 305 described above, and may include a projection or a recess.

The capturing body provided in the disk drive unit 100 may be one of the first through fifth capturing members 301 through 305, or be at least two of the first through fifth capturing members 301 through 305. In addition, the position where the capturing body is provided is not limited to the examples of the positions described above for the first through fifth capturing members 301 through 305. The capturing body may be provided anywhere within a space communicating from the first gas-liquid interface 116 or the second gas-liquid interface 120 to the disk accommodating space 24 where the magnetic recording disk 8 may be accommodated.

As described above, according to the disk drive unit 100 in the first embodiment, the capturing body may capture the lubricant 92 vaporizing from the first gas-liquid interface 116 or the second gas-liquid interface 120, in order to prevent the lubricant 92 from scattering to the disk accommodating space 24. Further, by preventing the surface contamination of the magnetic recording disk 8 due to the scattering of the lubricant 92, the generation of the read error or the write error with respect to the magnetic recording disk 8 may be reduced in the disk drive unit 100, to thereby improve the reliability of the disk drive unit 100.

### Second Embodiment

Next, a description will be given of a second embodiment. A description of those parts of the second embodiment that are the same as those corresponding parts of the first embodiment will be omitted, and a description will mainly be given of the parts that are different from those of the first embodiment.

The disk drive unit in the second embodiment may include a rotary-shaft type fluid dynamic bearing in which a lubricant exists between a shaft member and a bearing member, and a capturing body that captures the lubricant vaporizing from a gas-liquid interface.

<Configuration of Disk Drive Unit>

The disk drive unit 100 in the second embodiment may include the top cover 2 and the base 4. The magnetic recording disk 8 and the data read and write part 10 may be provided in the space between the top cover 2 and the base 4, similarly to the first embodiment, as illustrated in FIGS. 1A, 1B, and 1C.

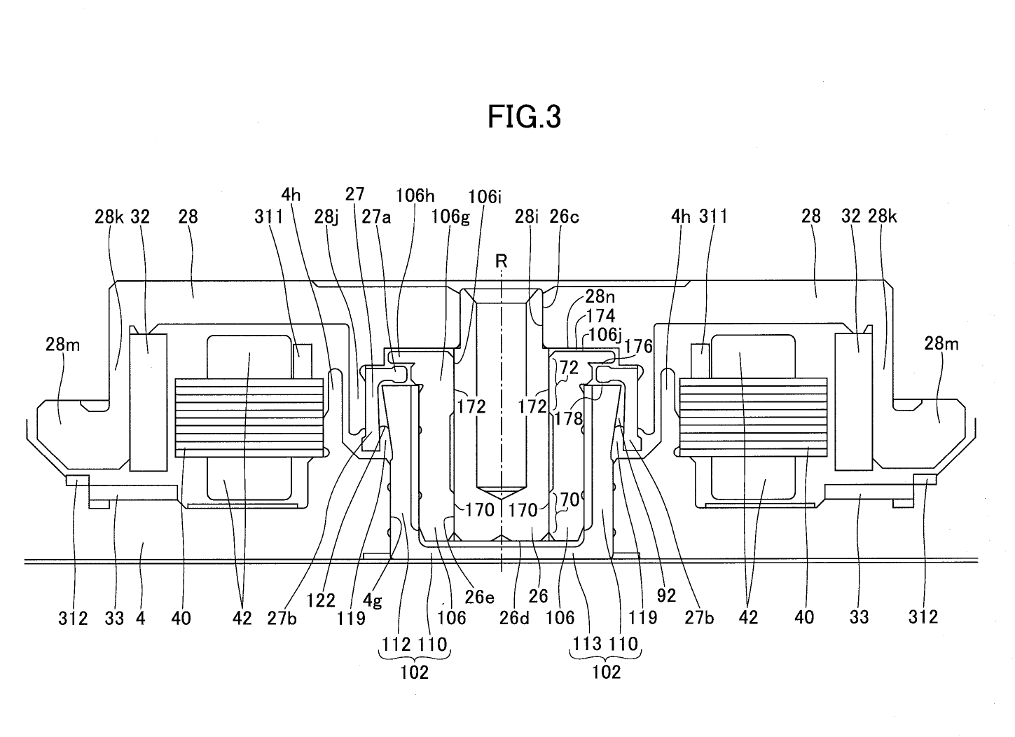

A description will be given of the bearing mechanism of the disk drive unit 100, by referring to FIG. 3. FIG. 3 illustrates a cross sectional view of the disk drive unit 100 along the line A-A in FIG. 1C.

The disk drive unit 100 may include a rotor that is set with the magnetic recording disk 8 and rotates, a bearing unit that rotatably supports the rotor, and a fixed body that supports the bearing unit.

The rotor may include a hub 28, a cylindrical magnet 32, and a thrust member 27. The bearing unit may include a shaft 26 and a sleeve 106. The fixed body may include the base 4, a laminated (or stacked) core 40, a coil 42, and a housing 102.

In the disk drive unit 100 of the second embodiment, the shaft 26 and the hub 28 may rotate by being supported by the sleeve 106 and the housing 102 that surround the shaft 26. A lubricant 92 may be provided in a gap between shaft 26 and the sleeve 106.

(Base)

The base 4 may include a center hole 4g to receive the housing 102 that is fixed to the base 4, and a cylindrical projecting part 4h that is provided to surround the center hole 4g. The base 4 may hold the housing 102 that is press fit, or bonded, or press fit and bonded into the center hole 4g, and the laminated core 40 may be fixed on the outer peripheral side of the projecting part 4h.

(Housing)

The housing 102 may be press fit, bonded, or press fit and bonded into the center hole 4g of the base 4. In addition, the housing 102 may include a sleeve surrounding part 112 that surrounds the sleeve 106, and a shaft holding part 110 that seals and holds a lower end surface of the sleeve 106 and a lower end surface of the shaft 26, to form an approximate cup shape.

The housing 102 may include the sleeve surrounding part 112 and the shaft holding part 110 that are integrally formed in this example, however, the sleeve surrounding part 112 and the shaft holding part 110 may be formed as separate parts that are bonded together.

(Sleeve)

The sleeve 106 may be press fit, or bonded, or press fit and bonded to the inner peripheral surface of the housing 102, coaxially to the center hole 4g of the base 4. The sleeve 106 may include a ring-shaped cylindrical part 106g that surrounds the shaft 26, and a flange part 106h extending on the outer peripheral side of the cylindrical part 106g. The sleeve 106 includes the cylindrical part 106g and the flange part 106h that are integrally formed in this example, however, the cylindrical part 106g and the flange part 106h may be formed as separate parts that are bonded together.

(Hub)

The hub 28 may include a center hole 28i provided at a center portion thereof, a first cylindrical part 28j surrounding the center hole 28i, a second cylindrical part 28k provided on the outer peripheral side of the first cylindrical part 28j, and a disk setting part 28m on which a magnetic recording disk 8 is to be set, provided at the lower end on the outer peripheral side of the second cylindrical part 28k.

A thrust member 27 may be provided on an inner peripheral surface of the first cylindrical part 28j of the hub 28. In addition, a cylindrical magnet 32 may be provided on an inner peripheral surface of the second cylindrical part 28k of the hub 28. The cylindrical magnet 32 may be fixed to a position opposing the laminated core 40 that is provided on the base 4.

The hub 28 may rotate integrally with the shaft 26 that is fixed to the center hole 28i, and rotate together with the magnetic recording disk 8 that is set on the disk setting part 28m.

(Attraction Plate)

An attraction plate 33 may be provided on the base 4 at a position opposing, via a gap, a lower surface of the cylindrical magnet 32 that is provided on the inner peripheral surface of the second cylindrical part 28k of the hub 28.

The attraction plate 33 may be formed by a ring-shaped member that is pressed from a cold-rolled steel plates made of a soft magnetic material, for example. The attraction plate 33 and the cylindrical magnet 32 may be configured to generate a magnetic force that attracts the attraction plate 33 and the cylindrical magnet 32 towards each other. A floating force may be generated when the hub 28 rotates to urge the hub 29 upwards, however, the hub 28 may rotate in a stable manner by balancing the attraction force between the attraction plate 33 and the cylindrical magnet 32 and the floating force acting on the hub 28.

(Shaft)

The shaft 26 may include a stepped part 26c, and may be fixed to the sub by press fitting, or bonding, or press fitting and bonding the stepped part 26c into the center hole 28i of the sub 28 at the time of assembling. A lower end surface 26d of the shaft 26 may be supported by the shaft holding part 110 of the housing 102.

(Thrust Shaft)

The thrust member 27 may include a ring part 27a surrounding the sleeve 106, and a downwardly hanging part 27b surrounding the housing 102. The ring part 27a and the downwardly hanging part 27b of the thrust member 27 may be fixed to the inner peripheral surface of the first cylindrical part 28j, and the thrust member 27 may rotate together with the hub 28.

A gap may be formed between the ring part 27a of the thrust member 27 and the each of the flange part 106h and the cylindrical part 106g of the sleeve 106. In addition, a gap may be formed between the downwardly hanging part 27b of the thrust member 27 and the outer peripheral surface of the sleeve surrounding part 112 of the housing 102.

The ring part 27a of the thrust member 27 may be provided between the flange part 106h of the sleeve 106 and the upper surface of the sleeve surrounding part 112 of the housing 102. By this configuration of the thrust member 27, when shock is applied in the direction of the rotational axis of the disk drive unit 100, the ring member 27a engages the flange part 106h and prevents the shaft 26 and the hub 28 from disengaging from the sleeve 106.

A tapered seal 119, that has an interval spreading in an upward direction and narrowing in the downward direction, may be formed between the inner peripheral surface of the downwardly hanging part 27b of the thrust member 27 and the outer peripheral surface of the sleeve surrounding part 112 of the housing 102. The provision of the tapered seal 119 may prevent the lubricant 92 from leaking to the outside.

The thrust member 27 may be press fit, or bonded, or press fit and bonded to the first cylindrical part 28j of the hub 28. The thrust member 27 in the second embodiment may be bonded and fixed to the first cylindrical part 28j of the hub 28. According to this configuration of the thrust member 27, the downwardly hanging part 27b may be prevented from becoming deformed by the press fitting and the dimension accuracy may be prevented from deteriorating.

(Dynamic Pressure Generator)

The lubricant 92 may be provided in a gap between an outer peripheral surface 26e of the shaft 26 and an inner peripheral surface 106i of the sleeve 106. A first radial dynamic pressure generator 170 may be formed under the shaft 26, and a second radial dynamic pressure generator 172 may be formed above the shaft 26.

The inner peripheral surface 106i of the sleeve 106 may include a first radial dynamic pressure generating groove 70 having a herringbone shape or a spiral shape, for example, at a portion opposing the first radial dynamic pressure generator 170. In addition, the inner peripheral surface 106iu of the sleeve 106 may include a second radial dynamic pressure generating groove 72 having the herringbone shape of the spiral shape, for example, at a portion opposing the second radial dynamic pressure generator 172.

One of or both the first radial dynamic pressure generating groove 70 and the second radial dynamic pressure generating groove 72 may be formed on the outer peripheral surface 26e of the shaft 26.

The lubricant 92 may be provided in a gap between the upper surface 106j of the sleeve 106 and a lower surface 28n of the hub 28, to thereby form a first thrust dynamic pressure generator 174. One of the upper surface 106j of the sleeve 106 and the lower surface 28n of the hub 28 may include a first thrust dynamic pressure generating groove having a herringbone shape or a spiral shape, for example.

In addition, the lubricant 92 may be provided in a gap between the upper surface of the ring part 27a of the thrust member 27 and the lower surface of the flange part 106h of the sleeve 106, and a gap between the lower surface of the ring part 27a of the thrust member 27 and the upper surface of sleeve surrounding part 112 of the housing 102.

One of or both the upper surface of the ring part 27a of the thrust member 27 and the lower surface of the flange part 106h of the sleeve 106 may include a second thrust dynamic pressure generating groove having the herringbone shape or the spiral shape, for example. A second thrust dynamic pressure generator 176 may be formed between the upper surface of the ring part 27a of the thrust member 27 and the lower surface of the flange part 106h of the sleeve 106. One of or both the lower surface of the ring part 27a of the thrust member 27 and the upper surface of the sleeve surrounding part 112 of the housing 102 may include a third thrust dynamic pressure generating groove having the herringbone shape or the spiral shape, for example. A third thrust dynamic pressure generator 178 may be formed between the lower surface of the ring part 27a of the thrust member 27 and the upper surface of the sleeve surrounding part 112 of the housing 102.

The thrust dynamic pressure generator may include at least one of the first thrust dynamic pressure generator 174, the second thrust dynamic pressure generator 176, and the third thrust dynamic pressure generator 178.

When the shaft 26 and the hub 28 rotate with respect to the sleeve 106, the dynamic pressure may be generated in the lubricant 92 at each of the first radial dynamic pressure generator 170, the second radial dynamic pressure generator 172, the first thrust dynamic pressure generator 174, the second thrust dynamic pressure generator 176, and the third thrust dynamic pressure generator 178. The shaft 26 and the hub 28 may be supported in the radial direction and the direction of the rotational axis by the dynamic pressure generated in the lubricant 92, in a non-contact state in which no contact is made with the sleeve 106 and the sleeve surrounding part 112 of the housing 102.

(Gas-Liquid Interface)

A gas-liquid interface 122 of the lubricant 92 may be formed between the outer peripheral surface of the sleeve surrounding part 112 of the housing 102 and the inner peripheral surface of the downwardly hanging part 27b of the thrust member 27. Because the gas-liquid interface 122 is positioned at the tapered seal 119, the lubricant 92 may be sealed by capillarity to prevent the lubricant 92 from leaking to the outside.

(Capturing Body)

The disk drive unit 100 may include a capturing body to capture the lubricant 92 vaporizing from the gas-liquid interface 122. The capturing body may be formed by a porous element having at least a part thereof formed by a porous material. The capturing body may be provided in a space communicating from the gas-liquid interface 122 to the disk accommodating space 24 in which the magnetic recording disk 8 may be accommodated.

The disk drive unit 100 in the second embodiment may include, as the capturing body, a first capturing member 311 and a second capturing member 312.

The first capturing member 311 may be provided by being bonded and fixed to the upper surface on the inner peripheral side of the laminated core 40 on the inner peripheral side of the coil 42.

The first capturing member 311 may capture the lubricant 92 vaporizing from the gas-liquid interface 122 and scattering between the first cylindrical part 28j of the hub 28 and the projecting part 4h of the base 4, in order to prevent the lubricant 92 from scattering to the disk accommodating part 24.

The second capturing member 312 may be fixed to the outer peripheral side of the attraction plate 33 of the base 4, to oppose a disk setting part 28m of the sub 28.

The second capturing member 312 may capture the lubricant 92 vaporizing from the gas-liquid interface 122, and scattering between the first cylindrical part 28j of the sub 28 and the projecting part 4h of the base 4, and between the cylindrical magnet 32 and the laminated core 40.

The capturing body provided in the disk drive unit 100 may be at least one of the first capturing member 311 and the second capturing member 312. In addition, the position where the capturing body is provided is not limited to the examples of the positions described above for the first and second capturing members 311 and 312. The capturing body may be provided anywhere within a space communicating from the gas-liquid interface 122 to the disk accommodating space 24 where the magnetic recording disk 8 may be accommodated.

As described above, according to the disk drive unit 100 in the second embodiment, the capturing body may capture the lubricant 92 vaporizing from the gas-liquid interface 122, in order to prevent the lubricant 92 from scattering to the disk accommodating space 24. Further, by preventing the surface contamination of the magnetic recording disk 8 due to the scattering of the lubricant 92, the generation of the read error or the write error with respect to the magnetic recording disk 8 may be reduced in the disk drive unit 100, to thereby improve the reliability of the disk drive unit 100.

A connecting part between the shaft 26 and the housing 102, a connecting part between the housing 102 and the base 4, and a connecting part between the cap 12 and the hub 28 in the first embodiment, and a connecting part between the shaft 26 and the hub 28, and a connecting part between the housing 102 and the base 4 in the second embodiment, may be fixed by welding, for example. When the welding is employed for these connecting parts, a superior connecting strength may be obtained, to thereby improve the shock resistance of the disk drive unit 100. In addition, compared to bonding, the welding enables the connection with a short connecting distance between the connected parts, and thus, the thickness of the disk drive unit 100 may be reduced.

Foreign matter may adhere on the surface of a welding part to be welded. In this case, a peel preventing cover may be provided on the surface of the welding part, in order to prevent peeling of the foreign matter. The peel preventing cover may be formed by coating liquid resin on the surface of the welding part, for example, and thereafter curing the liquid resin by applying heat or ultraviolet light, for example.

The bonding part may be fixed by combining the bonding, press fit and bonding, and welding. For example, the welding may be employed locally, and the bonding or the press fit and bonding may be used at other locations. Because a constant connecting strength may be obtained at the welded part, it may be possible to avoid deformation of the connecting part that may be caused by shrinking of the adhesive when the bonding is employed.

According to each of the embodiments, it may be possible to provide a disk drive unit that may prevent adhesion of the lubricant onto the disk surface, and reduce generation of the operation error.

Although the embodiments of the present invention have been described in detail, it should be understood that the various changes, substitutions, and alterations could be made hereto without departing from the spirit and scope of the invention.

What is claimed is:

1. A disk drive unit comprising:
a rotor including a disk setting part on which a disk is set;
a bearing unit configured to rotatably support the rotor, wherein the bearing unit includes a shaft member and a bearing member surrounding the shaft member, and a lubricant provided in a gap between the shaft member and the bearing member;
a fixed body configured to support the bearing unit; and
a capturing body, provided in a space communicating from a gas-liquid interface of the lubricant to a disk accommodating space in which the disk is accommodated, configured to capture the lubricant vaporizing from the gas-liquid interface.

2. The disk drive unit as claimed in claim 1, wherein at least a part of the capturing body is formed by a porous material.

3. The disk drive unit as claimed in claim 2, wherein the porous material is sintered metal or activated carbon.

4. The disk drive unit as claimed in claim 1, wherein the capturing body includes a first capturing member surrounding at least a part of the shaft member on a side opposite to the fixed body.

5. The disk drive unit as claimed in claim 1, wherein the capturing body includes a second capturing member covering at least a part of the gas-liquid interface.

6. The disk drive unit as claimed in claim 1, wherein the capturing body includes a third capturing member provided on an outer peripheral surface of the shaft member.

7. The disk drive unit as claimed in claim 1, wherein
the fixed body includes a stator core on a surface opposing the rotor in an axial direction of the shaft member, and
the capturing body includes a fourth capturing member provided on the stator core.

8. The disk drive unit as claimed in claim 1, wherein the capturing body includes a fifth capturing member provided in a gap between the rotor and the fixed body that oppose each other, in a region on an outer peripheral side of the bearing member.

9. A disk drive unit comprising:
a rotor including a disk setting part on which a disk is set;
a bearing unit configured to rotatably support the rotor, wherein the bearing unit includes a shaft member and a bearing member surrounding the shaft member, and a lubricant provided in a gap between the shaft member and the bearing member;
a fixed body configured to support the bearing unit; and
a porous element, having at least a part thereof formed by a porous material, provided in a space communicating from a gas-liquid interface of the lubricant to a disk accommodating space in which the disk is accommodated.

10. The disk drive unit as claimed in claim 9, wherein the porous element includes a first capturing member surrounding at least a part of the shaft member on a side opposite to the fixed body.

11. The disk drive unit as claimed in claim 9, wherein the porous element includes a second capturing member covering at least a part of the gas-liquid interface.

12. The disk drive unit as claimed in claim 9, wherein the porous element includes a third capturing member provided on an outer peripheral surface of the shaft member.

13. The disk drive unit as claimed in claim 9, wherein
the fixed body includes a stator core on a surface opposing the rotor in an axial direction of the shaft member, and
the porous element includes a fourth capturing member provided on the stator core.

14. The disk drive unit as claimed in claim 9, wherein the porous element includes a fifth capturing member provided in a gap between the rotor and the fixed body that oppose each other, in a region on an outer peripheral side of the bearing member.

15. A disk drive unit comprising:
a rotor including a disk setting part on which a disk is set;
a bearing unit configured to rotatably support the rotor, wherein the bearing unit includes a shaft member and a bearing member surrounding the shaft member, and a lubricant provided in a gap between the shaft member and the bearing member;
a fixed body configured to support the bearing unit; and
an element, having at least a part thereof formed by sintered metal or activated carbon, provided in a space communicating from a gas-liquid interface of the lubricant to a disk accommodating space in which the disk is accommodated.

16. The disk drive unit as claimed in claim 15, wherein the element includes a first capturing member surrounding at least a part of the shaft member on a side opposite to the fixed body.

17. The disk drive unit as claimed in claim 15, wherein the element includes a second capturing member covering at least a part of the gas-liquid interface.

18. The disk drive unit as claimed in claim 15, wherein the element includes a third capturing member provided on an outer peripheral surface of the shaft member.

19. The disk drive unit as claimed in claim 15, wherein
the fixed body includes a stator core on a surface opposing the rotor in an axial direction of the shaft member, and
the element includes a fourth capturing member provided on the stator core.

20. The disk drive unit as claimed in claim 15, wherein the element includes a fifth capturing member provided in a gap between the rotor and the fixed body that oppose each other, in a region on an outer peripheral side of the bearing member.
